(19) United States
(12) Patent Application Publication
(10) Pub. No.: US 2010/0135003 A1
(43) Pub. Date: Jun. 3, 2010

(54) Backlight Module and Liquid Crystal Display Module Using the Backlight Module

(75) Inventors: Yen-Chang Huang, Hsin-Chu (TW); Kang-Chung Liu, Hsin-Chu (TW); Wen-Yuan Cheng, Hsin-Chu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORPORATION, Hsin-Chu (TW)

(21) Appl. No.: 12/493,393

(22) Filed: Jun. 29, 2009

(30) Foreign Application Priority Data
Nov. 28, 2008 (TW) 97146436

(51) Int. Cl. G09F 13/04

(52) U.S. Cl. 362/97.2

(57) ABSTRACT

This present invention discloses a backlight module and a flat display device using the backlight module. The backlight module has a plastic base having a plastic plate and a plastic frame, wherein a light guide plate is disposed on the plastic plate. The plastic plate is light reflective and has a thickness ranging from 0.2 mm to 0.9 mm. The plastic plate is used to reflect light leaking from the light guide plate. The reflectivity of the plastic plate to the visible light with wavelength ranging from 410 nm to 780 nm ranges from 80% to 95%.

### BACKGROUND OF THE INVENTION

1. Field of the Invention

This invention relates to a backlight module and a flat display device using the same and specifically to an edge lighting backlight module and a flat display device using the edge lighting backlight module.

2. Description of the Prior Art

Display panels and flat display devices using the display panels are gradually becoming the mainstream in the field of display devices. Liquid crystal display panels are particularly popular among display panels and are extensively used in various types of electronic devices such as display screens, home flat televisions, liquid crystal displays of personal computers or of laptop computers, or display screens of mobile phones and digital cameras.

Backlight module is one of the key components of the liquid crystal display panel. Liquid crystal itself does not emit light and thus the function of the backlight module is to provide adequate and evenly distributed light source for the liquid crystal display panels to properly display images.

A conventional backlight module includes a plastic frame, a light guide plate, a reflector, a light source module, and a set of optical films. FIG. 1A is a schematic view of the plastic frame 10 and the reflector 20. FIG. 1B is a cross-sectional view of the plastic frame 10 and the reflector 20 along line C-C′. The middle section of the plastic frame 10 is penetrating and hollow while the reflector is attached to the bottom of the plastic frame 10 and covers the hollow middle part of the plastic frame 10. Light guide plate (not illustrated) is disposed in the space enclosed by the reflector 20 and the plastic frame 10. Light is emitted into the lateral side of the light guide plate from the light source disposed next to the light guide plate. The light guide plate also changes the traveling direction of the light so that the light can be emitted from a surface of the light guide plate opposite to the reflector 20. In this way, the reflector 20 will reflect light from the bottom of the light guide plate back to the light guide plate for reuse which improves the overall optical efficiency of the backlight module.

Furthermore, normally a metallic lower frame or a backplate (not illustrated) is disposed at the bottom of the plastic frame 10 to maintain the overall strength of the backlight module. The metallic lower frame or the backplate can also be used to fix the reflector on the bottom of the plastic frame 10. Therefore, in the backlight module illustrated in FIG. 1A and FIG. 1B, the procedures of attaching the reflector 20 to the plastic frame 10 and the backplate will increase the assembly procedures and the overall cost. In addition, the penetrating and hollow structure of the plastic frame 10 also decreases the overall strength of the plastic frame 10. However, as for liquid crystal panels of smaller dimension (such as the ones having diagonal shorter than 15 cm), the above-mentioned metallic backplate may be omitted. As FIG. 1B shows, the reflector 20 is disposed on the bottom-most part of the backlight module. The reflector 20 is attached to only edges of the bottom of the plastic frame 10 and thus the reflector 20 may be accidentally detached during other procedures. This increases the possibility of reattaching the reflector 20 to the plastic frame 20 and also reduces the overall production yield.

### SUMMARY OF THE INVENTION

It is an object of the present invention to provide a backlight module and a flat display device having the same for reducing reflector material and the overall production cost of the backlight module.

It is another object of the present invention to provide a backlight module and a flat display device having the same, wherein the overall strength of the backlight module is increased.

It is yet another object of the present invention to provide a backlight module and a flat display device having the same, wherein the reflective plastic frame replaces the conventional reflector to maintain the overall reflectivity and luminance.

It is yet another object of the present invention to provide a backlight module and a flat display device having the same, wherein a monolithic plastic frame is used to simplify the production procedures and cost.

The present invention provides a backlight module including a plastic base made of plastics for other components such as a light guide plate, a light source, a light diffuser, a brightness enhancement film, or a fastener to be disposed thereon. The backlight module of the present invention is an edge-lighting backlight module. In other words, the light source emits light toward a light entry surface of the light guide plate. The light guide plate accepts light from the light source and also alters the travelling direction of the light. Eventually the light travels toward a light diffuser. The light diffuser accepts and harmonizes the light from the light guide plate. The harmonized light is then emitted from the light diffuser toward a brightness enhancement film (BEF). The BEF allows the light to be concentrated through refraction and reflection within the BEF. Thus the BEF increases the optical efficiency of light emitted from the light diffuser and improves the overall luminance.

The plastic base includes a plastic plate and a plastic frame, wherein the light guide plate is disposed on the plastic plate. The plastic plate faces the surface of the light guide plate and reflects the light leaking from the light guide plate for reuse and thus increases the overall optical efficiency of the backlight module. The reflectivity of the plastic plate for the visible light having a wavelength ranging from 410 nm to 780 nm ranges from 80% to 95%. Furthermore, the diagonal length of the plastic plate ranges from 2.54 cm to 12.7 cm.

In different embodiments, the plastic base includes a lower reflectivity element disposed thereon for absorbing at least part of the light concentrated on the plastic base. The lower reflectivity element can be disposed at the edge of the plastic plate close to the plastic frame or on the inner surface of the plastic frame according to the location and area of the light concentrated on the plastic frame. The lower reflectivity element includes a black ink pattern sprayed on the plastic plate or a black tape, but is not limited thereto. In different embodiments, the lower reflectivity element may include an ink pattern of other colors, tape of other colors, or other suitable materials pasted on the plastic plate. Furthermore, the reflectivity of the lower reflectivity element to the visible light ranges from 0.0001% to 30% and can be adjusted by changing the materials of the lower reflectivity element and the ratio of materials.

The present invention also provides a flat display device which includes a backlight module, a display panel, a front cover and a back cover. The backlight module includes a plastic base which is made of plastic material reflective to light, wherein the plastic base includes a plastic plate and a plastic frame. A light guide plate is disposed on the plastic plate, wherein the diagonal length of the plastic plate ranges from 2.54 cm to 12.7 cm. The front cover and the back cover together cover and protect the display panel as well as the backlight module. The backlight module is disposed between the back cover and the display panel. The display panel is disposed between the backlight module and the front cover. The front cover includes a display opening for the display panel to display images through the display opening.

### BRIEF DESCRIPTION OF THE DRAWINGS

FIG. 1A is a schematic view of a conventional plastic frame in a backlight module;

FIG. 1B is a cross-sectional view of the conventional plastic frame in a backlight module;

FIG. 2 is an exploded view of the backlight module of the present invention;

FIG. 3 is a perspective view of the plastic base in the backlight module of the present invention;

FIG. 4A and FIG. 4B are respectively a top view and a cross-sectional view of the plastic base illustrated in FIG. 3;

FIG. 5 illustrates the reflectivity of the plastic bases of different thicknesses for visible light of different wavelengths;

FIG. 6A and FIG. 6B illustrates a modification of the plastic base illustrated in FIG. 3; and

FIG. 7 is an exploded view of a flat display device of the present invention.

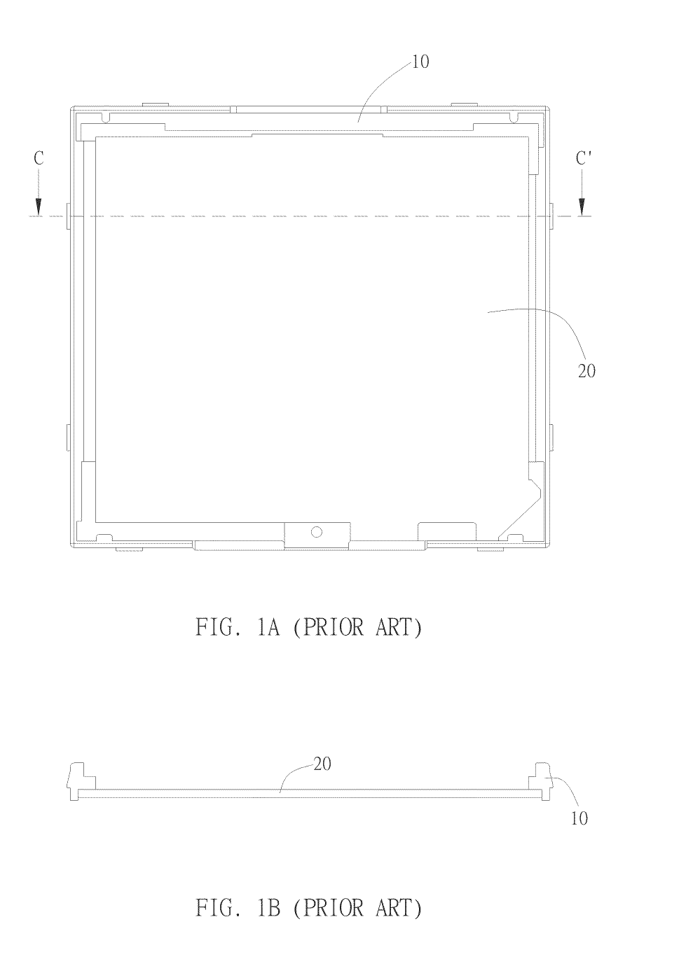

### DETAILED DESCRIPTION OF THE PREFERRED EMBODIMENT

The present invention discloses a backlight module and a flat display device having the same. The plastic base of the backlight module is reflective to light, which combines the function of a conventional reflector and a conventional plastic frame to eliminate the need for the conventional reflector. Thus the use of the plastic base of the present invention saves reflector material, simplifies assembly procedures of backlight module, and reduces the overall assembly cost. The backlight module of the present invention is preferably applied to small-sized display panels or small sized display devices. The small-sized display panels generally include liquid crystal display panels with diagonal length ranging from substantially 2.54 cm (1 inch) to 12.7 cm (5 inches).

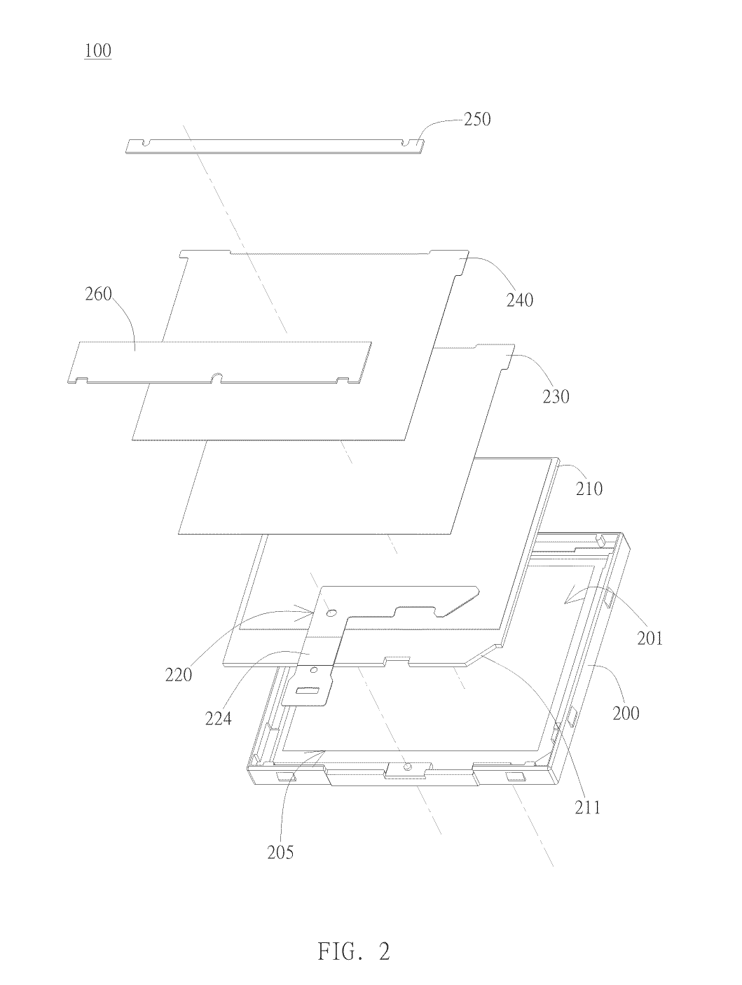

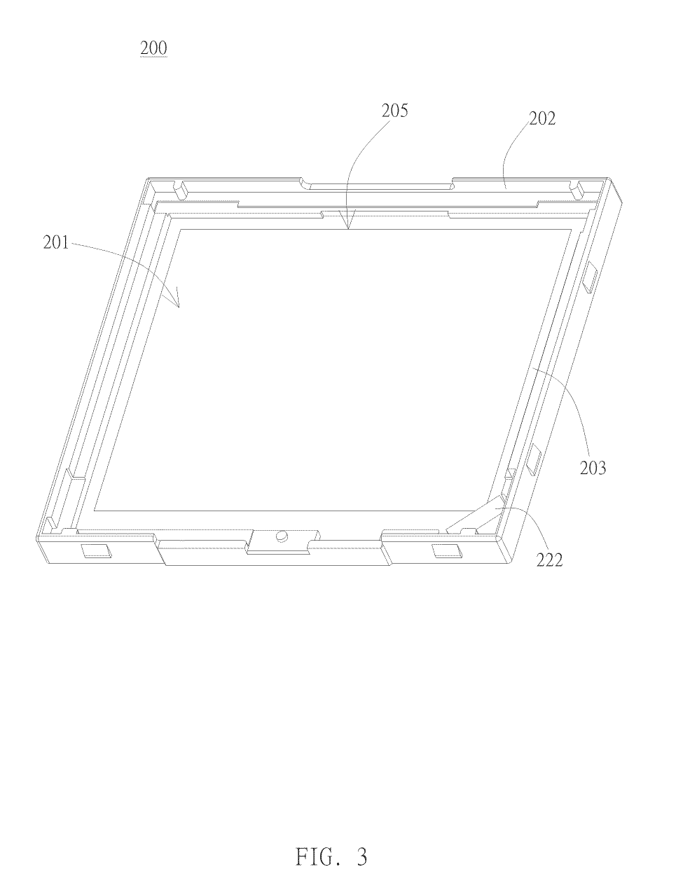

FIG. 2 is an exploded view of the backlight module 100 of the present invention. The backlight module 100 includes a plastic base 200, a light guide plate 210, a light source module (light bar) 220, a light diffuser 230, a brightness enhancement film (BEF) 240, a first fastener 250, and a second fastener 260. As FIG. 2 shows, the plastic base 200 can have a rectangular or rectangular-like space 201, wherein the light guide plate 210, the light source module 220, the light diffuser 230, and the BEF 240 are piled up and disposed within the space 201. In the present invention, the backlight module 100 is an edge-lighting backlight module while the light source 222 (see FIG. 3) of the light source module 220 is disposed on one side or at one corner of the space 201 and adjacent to the light guide plate 210 and electrically connected to the bottom surface of the circuit board 224 (see FIG. 2) of the light source module 220. Please refer to FIG. 3 and FIG. 2, wherein part of the circuit board 224 (omitted in FIG. 3) of the light source module 220 overlaps the plastic base 200 and the light guide plate 210 while part of the circuit board 224 protrudes out of the plastic base 200. The circuit board 224 is a flexible printed circuit board or a printed circuit board. The light source 222 is preferably a light bar consisting of light emitting diodes (especially side emitted type LEDs) disposed at a corner of the space 201 (such as the bottom right corner), but is not limited thereto. In different embodiments, the light source 222 of the light source module 220 may include cold cathode fluorescent lamps, hot cathode fluorescent lamps, or other suitable fluorescent lamps. The first fastener 250 and the second fastener 260 are disposed on the BEF 240 and fix the light guide plate 210, the light source module 220, the light diffuser 230 and the BEF 240 within the space 201 of the plastic base 200.

In the embodiment illustrated in FIG. 2 and FIG. 3, the light entry surface 211 of the light guide plate 210 accepts light from the light source 222 of the light source module 220. The light guide plate 210 changes the traveling direction of the light in such a way that the light is emitted from a surface of the light guide plate 210 facing the light diffuser 230 and into the light diffuser 230 and then the BEF 240. The function of the light diffuser 230 is to accept light from the light guide plate 210 and homogenize the light. The homogenized light is then emitted from a surface of the light diffuser 230 facing the BEF 240 and travels toward the BEF 240. The function of the BEF 240 is to accept light from the light diffuser 230 and converges the light by refraction or reflection within the BEF 240. In this way, the BEF 240 increases the overall luminance as well as the optical efficiency of light entered from the light diffuser 230.

FIG. 3 is a perspective view of the plastic base 200 and the light source 222. The plastic base 200 is made of plastic material having light reflectivity and is manufactured by processes such as injection molding. In the present embodiment, material of the plastic base 200 includes polyethylene (PE) or polycarbonate (PC), but is not limited thereto. In different embodiments, the material of the plastic base 200 can include additional materials for increasing the reflectivity of the entire plastic base 200, such as titanium dioxide (TiO₂) or barium sulphate (barium sulfate; BaSO4) but are not limited thereto. Furthermore, the ratio of materials used to make the plastic base 200 can be adjusted based on the required reflectivity or costs. The color of the plastic base 200 is preferably white, but is not limited thereto and can be adjusted according to the required reflectivity or costs.

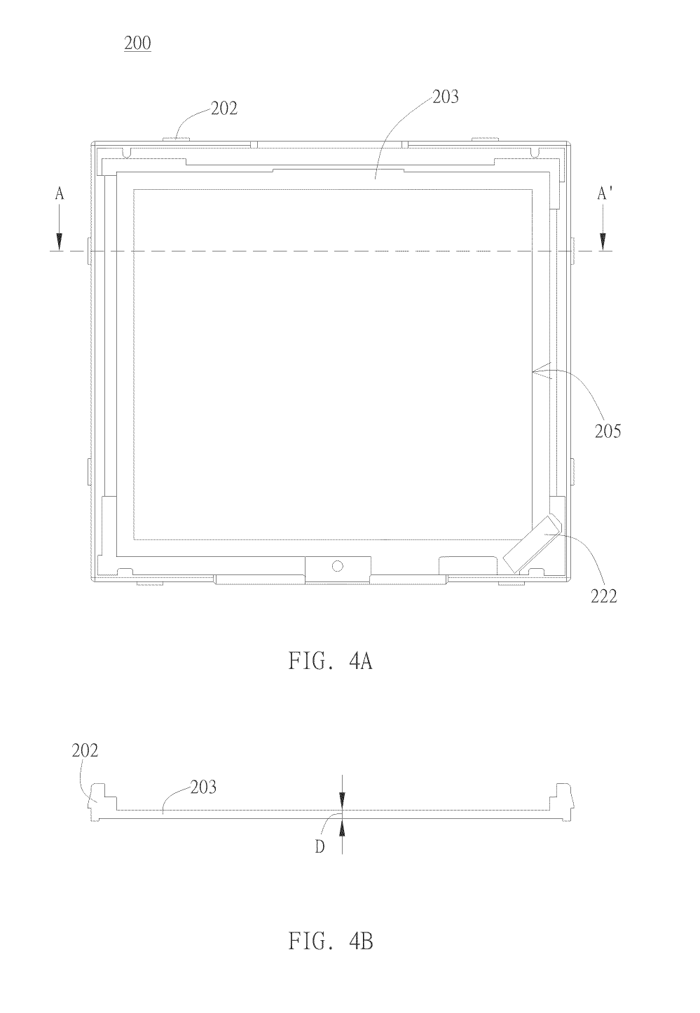

In the embodiment illustrated in FIG. 3, the plastic base 200 includes a plastic frame 202 and a plastic plate 203. The plastic frame 202 is formed at the edge of the plastic plate 203 and surrounds the plastic plate 203 to form the space 201. The light guide plate 210 is disposed on the plastic plate 203 within the space 201. The plastic plate 203 of the present embodiment is used to reflect the light leaking from bottom of the light guide plate. The light reflected by the plastic plate 203 can be reused to improve the overall light efficiency of the backlight module. FIG. 4A is a top view of the plastic base 200 and the light source 222 illustrated in FIG. 3. FIG. 4B is a cross-sectional side view of the plastic base 200 from line A-A′. As FIG. 4A and FIG. 4B show, the plastic plate 203 has a thickness of D.

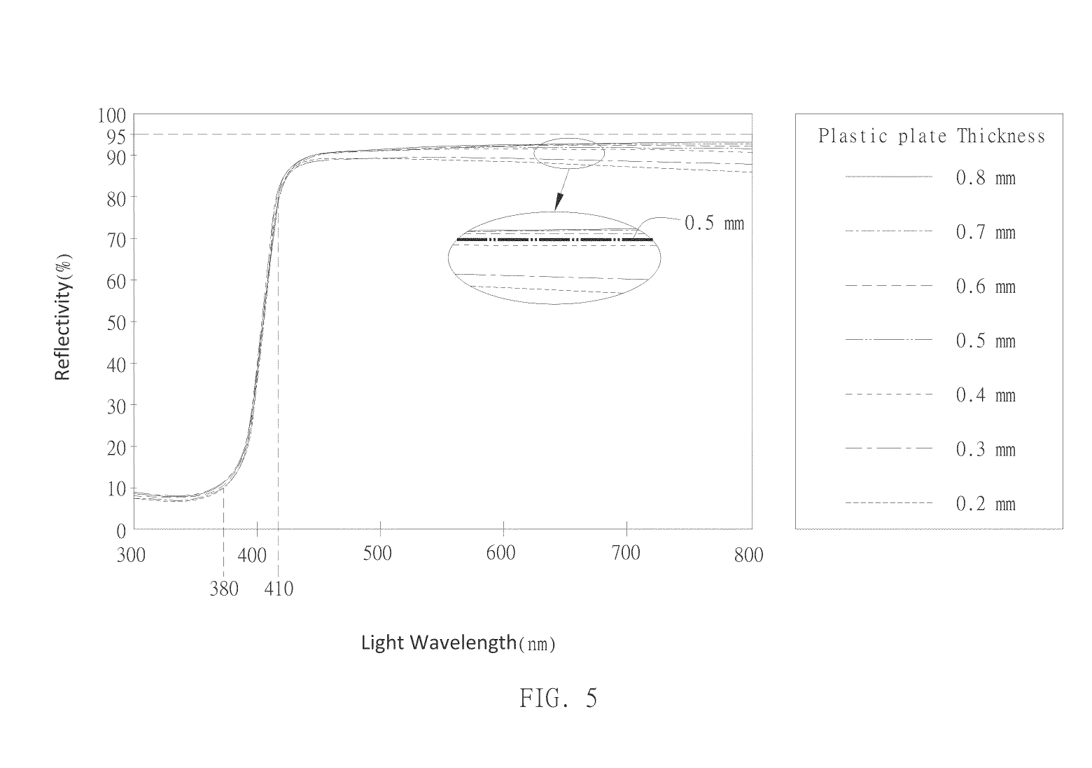

FIG. 5 illustrates the reflectivity of the plastic plate 203 of the plastic base 200 corresponding to visible light of different wavelengths (not illustrated according to actual scale), wherein curves respectively correspond to the plastic plates 203 of different thicknesses D. As FIG. 5 shows, the reflectivities of the plastic plates 203 of different thickness for visible light with wavelength from 380 nanometer (nm) to 410 nanometer (nm) are substantially lower. The reflectivity of the plastic plate 203 for the visible light with wavelength ranging from 380 nm to 410 nm ranges from 10% to 80%. Furthermore, for the plastic plate 203 with thickness greater than 0.5 mm, the corresponding reflectivity for visible light with wavelength greater than 410 nm approaches 95%. Thus the reflectivity of the plastic plate 203 for visible light ranges from 10% to 95%. In different embodiments, the reflectivity can be altered by adjusting the material of the plastic plate 203. For visible light of the same wavelength (such as the visible light with wavelength of 700 nm), the reflectivity of the plastic plate 203 increases as the thickness of the plastic plate 203 increases. In other words, the reflectivity for visible light is positive to or even directly proportional to the thickness of the plastic plate 203. However, for the plastic plate 203 having thickness greater than 0.5 mm, such as 0.6 mm, 0.7 mm, or 0.8 mm, the corresponding reflectivity approaches 95%, i.e. the plastic plate 203 has a limited maximum reflectivity for visible light.

Thus, for plastic plate 203 with thickness D ranging from 0.2 mm to 0.5 mm, the reflectivity for visible light ranges from 10% to 95%. Especially for visible light with wavelength ranging from 380 nm to 410 nm, the reflectivity for visible light ranges from 10% to 80%. For visible light with wavelength ranging from 410 nm to 780 nm, the reflectivity for visible light ranges from 80% to 95%.

Furthermore, for plastic plate 203 with thickness D ranging from 0.5 mm to 0.9 mm, the reflectivity for visible light ranges from 10% to 95%. For visible light with wavelength ranging from 380 nm to 410 nm, the reflectivity for visible light ranges substantially from 10% to 80%. Especially for visible with wavelength of 410 nm, the reflectivity even approaches 90%. For visible light with wavelengths ranging from 410 nm to 780 nm, the reflectivity for visible light ranges from 90% to 95%.

However, as the thickness D increases, its contribution to the increase in reflectivity diminishes. Furthermore, the increase in thickness D of the plastic plate 203 increases the overall cost of the backlight module. For instance, the reflectivity of the plastic plate 203 with thickness of 0.8 mm is substantially equal to that of the plastic plate 203 with thickness of 0.5 mm. The increase of 0.3 mm in thickness D of the plastic plate 203 will inevitably increase the overall cost of the backlight module. Thus, in a preferred embodiment, the thickness D of the plastic plate 203 ranges from 0.2 mm to 0.5 mm, but is not limited thereto.

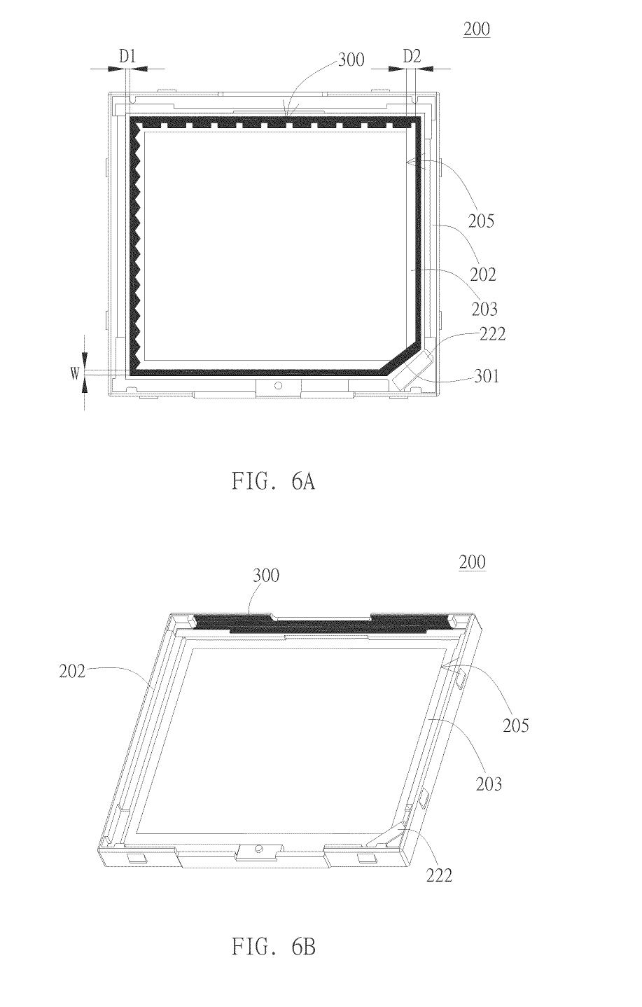

FIG. 6A and FIG. 6B illustrate a modification of the plastic base illustrated in FIG. 3. In the embodiment illustrated in FIG. 6A, the plastic base 200 further includes a lower reflectivity element 300 having the reflectivity lower than the reflectivity of the plastic frame 202 or the plastic plate 203 for absorbing light leaking from the light guide plate 210 and concentrated on part of the plastic base 200 to avoid local leakage of light which may affect the user's impression. The shape of the lower reflectivity element 300 may include triangle, rectangle, square, rhombus, circle, or ellipse, but is not limited thereto. In other words, the lower reflectivity element 300 is disposed on the plastic base 200 or any suitable location where light may be concentrated to avoid local light leakage due to the concentrated light, i.e. to avoid the so-called “bright band” phenomena.

In the present embodiment, the lower reflectivity element 300 is a black ink pattern sprayed on the plastic plate 203, but is not limited thereto. In different embodiments, the lower reflectivity element 300 may include an ink pattern of other colors, a tape of other colors, or other suitable materials coated or pasted on the plastic plate 203. Furthermore, the reflectivity of the lower reflectivity element 300 to the visible light ranges from 0.0001% to 30% and can be adjusted by changing the materials of the lower reflectivity element 300 and the ratio of materials.

As FIG. 6A shows, the lower reflectivity element 300 is disposed at the edge of the plastic plate 203 and close to the plastic frame 202. The distance D1 between the lower reflectivity element 300 and the plastic frame 202 is preferably less than 5 mm. The width W of the lower reflectivity element 300 ranges from 0.5 mm to 5 mm, but is not limited thereto. In different embodiments, the width of the lower reflectivity element 300 can be adjusted according to the material of the lower reflectivity element 300, area and intensity of the light concentrated or other factors. Furthermore, please refer to FIG. 2 and FIG. 6A, the lower reflectivity element 300 includes a lower reflectivity part 301 located at a corner of the plastic plate 203. The lower reflectivity part 301 corresponds to the light source 222 and the light entry surface 211 of the light guide plate 210. The function of the lower reflectivity part 301 is to absorb light leaking from the interface between the light guide plate 210 and the light source 220. Furthermore, in the embodiment illustrated in FIG. 6B, the lower reflectivity element 300 is disposed on the inner surface of the plastic frame 202, wherein the distance D2 between the lower reflectivity element 300 and the plastic plate 203 is smaller than 10 mm in order to absorb the visible light leaking from the edge of the light guide plate 210 and concentrated at the plastic frame 202. The distance D1, the width W, and/or the distance D2 are/is variable for the same lower reflectivity element 300 according to the shape of the lower reflectivity element 300. As FIG. 6B shows, the lower reflectivity element 300 is disposed on part of the inner surface of the plastic frame 202, but is not limited thereto. In different embodiments, the location and area of the lower reflectivity element 300 on the plastic frame 202 can be adjusted according to the location and area of the light concentrated on the plastic frame 202.

Please refer to FIG. 2, FIG. 3, FIG. 4A, FIG. 6A and FIG. 6B, the plastic plate 203 includes a white reflection area 205 (or a higher reflectivity area) at the middle of the plastic plate 203 corresponding to the bottom of the light guide plate 210. The reflectivity of the white reflection area 205 situated on a middle section of the plastic plate 203 to the visible light ranges from 10% to 95% which is higher than the reflectivity of the lower reflectivity element 300. The reflectivity of the white reflection area 205 to the visible light having wavelength ranging from 380 nm to 410 nm ranges from 10% to 80%. The reflectivity of the white reflection area 205 to the visible light having wavelength ranging from 410 nm to 780 nm ranges from 80% to 95%.

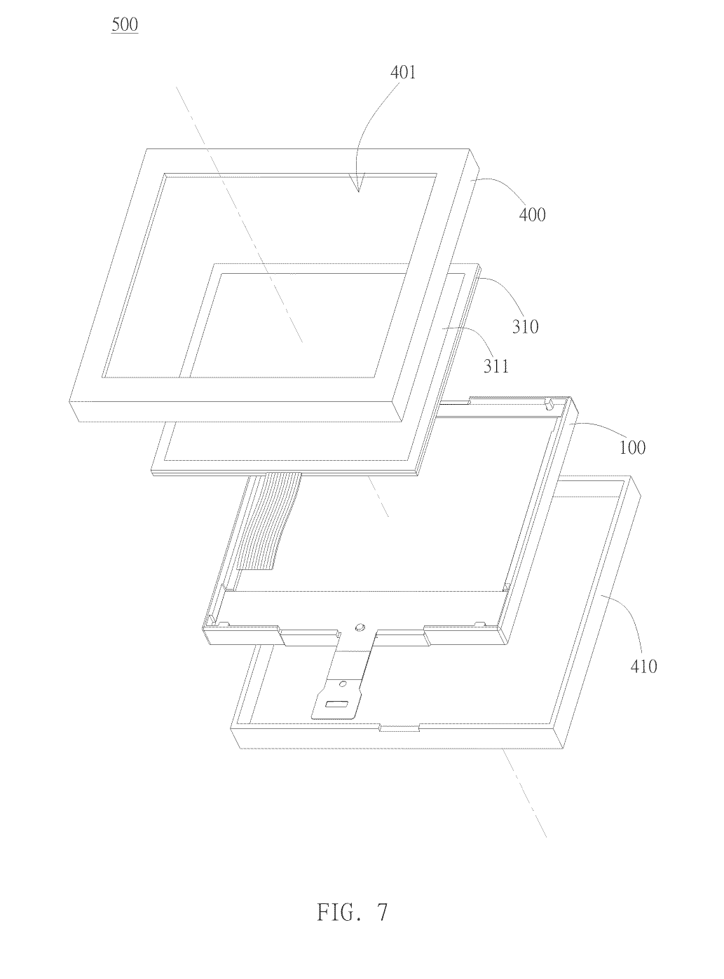

FIG. 7 is an exploded view of a flat display device 500 of the present invention. The flat display device 500 includes a backlight module 100, a display panel 310, a front cover 400, and a back cover 410. In the embodiment illustrated in FIG. 7, the backlight module 100 is the edge-lighting backlight module 100 illustrated in FIG. 2, but is not limited thereto. In different embodiments, the backlight module 100 in FIG. 7 may include the plastic plate 203 having the lower reflectivity element 300 illustrated in FIG. 6A and FIG. 6B.

In a preferred embodiment, the diagonal length of the display panel 310 ranges from 2.54 cm to 12.7 cm, but is not limited thereto. Furthermore, in order to be incorporated with the display panel 310, the diagonal length of the plastic plate 203 preferably ranges from 2.54 cm to 12.7 cm, but is not limited thereto.

Furthermore, the display panel 310 includes an active area 311 corresponding to the backlight module 100 to accept light from the backlight module 100. The display panel 310 then displays images through the active area 311. The front cover 400 and the back cover 410 are used to cover and protect the display panel 310 and the backlight module 100. Thus the backlight module 100 is disposed between the back cover 410 and the display panel 310 while the display panel 310 is disposed between the backlight module 100 and the front cover 400. The front cover 400 has a display opening 401, wherein the active area 311 of the display panel 310 displays images through the display opening 401.

The above is a detailed description of the particular embodiment of the invention which is not intended to limit the invention to the embodiment described. It is recognized that modifications within the scope of the invention will occur to a person skilled in the art. Such modifications and equivalents of the invention are intended for inclusion within the scope of this invention.

What is claimed is:

1. A backlight module, comprising:
a plastic base, including:
a plastic plate, wherein a thickness of the plastic plate ranges from 0.2 mm to 0.9 mm; and
a plastic frame surrounding the plastic plate;
a lower reflectivity element disposed on the plastic base, wherein a width of the lower reflectivity element ranges from 0.5 mm to 5 mm; and
a light source, disposed on the plastic base, for emitting a visible light, wherein a wavelength of the visible light ranges from 410 nm to 780 nm, and a reflectivity of the plastic plate for the visible light ranges from 80% to 95%.

2. A backlight module, comprising:
a plastic base, including:
a plastic plate, wherein a diagonal length of the plastic plate ranges from 2.54 cm to 12.7 cm, a thickness of the plastic plate ranges from 0.2 mm to 0.9 mm; and
a plastic frame surrounding the plastic plate;
a light guide plate disposed on the plastic plate, wherein the plastic frame surrounds the light guide plate; and
a light source disposed on the plastic base corresponding to a light entry surface of the light guide plate, wherein the light source emits a visible light toward the light entry surface;
wherein a reflectivity of the plastic plate for the visible light ranges from 10% to 95%.

3. The backlight module of claim 2, wherein a wavelength of the visible light ranges from 380 nm to 410 nm, the reflectivity of the plastic plate for the visible light having the wavelength ranging from 380 nm to 410 nm ranges from 10% to 80%.

4. The backlight module of claim 2, wherein a wavelength of the visible light ranges from 410 nm to 780 nm, the reflectivity of the plastic plate for the visible light having the wavelength ranging from 410 nm to 780 nm ranges from 80% to 95%.

5. The backlight module of claim 2, wherein the plastic plate has a material including polyethylene or polycarbonate.

6. The backlight module of claim 5, wherein the plastic plate has an additional material including titanium dioxide or barium sulphate.

7. The backlight module of claim 2, wherein the plastic plate includes a white reflection area situated on a middle section of the plastic plate corresponding to a bottom surface of the light guide plate.

8. The backlight module of claim 7, wherein the reflectivity in the white reflection area for the visible light ranges from 10% to 95%.

9. The backlight module of claim 7, wherein a wavelength of the visible light ranges from 380 nm to 410 nm, the reflectivity for the visible light having the wavelength ranging from 380 nm to 410 nm in the white reflection area ranges from 10% to 80%.

10. The backlight module of claim 7, wherein a wavelength of the visible light ranges from 410 nm to 780 nm, the reflectivity for the visible light having the wavelength ranging from 410 nm to 780 nm in the white reflection area ranges from 80% to 95%.

11. The backlight module of claim 2, further comprising a lower reflectivity element disposed on the plastic base corresponding to the light guide plate.

12. A backlight module, comprising:
a plastic base, including:
a plastic plate, wherein a thickness of the plastic plate ranges from 0.2 mm to 0.9 mm; and
a plastic frame surrounding the plastic plate;
a lower reflectivity element disposed on the plastic base and surrounded by the plastic frame;
a light guide plate disposed on the plastic plate and surrounded by the plastic frame; and
a light source disposed on the plastic base corresponding to a light entry surface of the light guide plate, wherein the light source emits a visible light toward the light entry surface;
wherein a reflectivity of the plastic plate for the visible light ranges from 10% to 95%.

13. The backlight module of claim 12, wherein the lower reflectivity element includes a lower reflectivity part disposed corresponding to the light source and the light entry surface of the light guide plate.

14. The backlight module of claim 12, wherein the lower reflectivity element is a black ink pattern or a black tape.

15. The backlight module of claim 12, wherein the lower reflectivity element is disposed on the plastic plate and distanced from the plastic frame by less than 5 mm.

16. The backlight module of claim 12, wherein the lower reflectivity element is disposed on the plastic frame and distanced from the plastic plate by less than 10 mm.

17. The backlight module of claim 12, wherein a width of the lower reflectivity element ranges from 0.5 mm to 5 mm.

18. The backlight module of claim 12, wherein a reflectivity of the lower reflectivity element for the visible light ranges from 0.0001% to 30%.

19. The backlight module of claim 12, wherein the lower reflectivity element has a shape of triangle, rectangle, square, rhombus, circle or ellipse.

20. A flat display device, comprising:
a backlight module as in claim 1;
a display panel, disposed corresponding to the backlight module; and
a display back cover and a display front cover;
wherein the backlight module is disposed between the display back cover and the display panel, the display panel is disposed between the backlight module and the display front cover, and a diagonal length of the display panel ranges from 2.54 cm to 12.7 cm.

21. A flat display device, comprising:
a backlight module as in claim 2;
a display panel, disposed corresponding to the backlight module; and
a display back cover and a display front cover;
wherein the backlight module is disposed between the display back cover and the display panel, and the display panel is disposed between the backlight module and the display front cover.

22. A flat display device, comprising:
a backlight module as in claim 12;
a display panel, disposed corresponding to the backlight module; and
a display back cover and a display front cover;
wherein the backlight module is disposed between the display back cover and the display panel, the display panel is disposed between the backlight module and the display front cover, and a diagonal length of the display panel ranges from 2.54 cm to 12.7 cm.
